(19) United States
(12) Patent Application Publication
(10) Pub. No.: US 2007/0172070 A1
(43) Pub. Date: Jul. 26, 2007

(54) Method and apparatus for audio matrix decoding

(75) Inventors: Yong-choon Cho, Suwon-si (KR); Sun-min Kim, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/500,294

(22) Filed: Aug. 8, 2006

(30) Foreign Application Priority Data
Sep. 28, 2005 (KR) 2005-90721

(51) Int. Cl. H04R 5/00

(52) U.S. Cl. 381/22; 381/20

(57) ABSTRACT

An enhanced audio matrix decoding method and apparatus to generate a multi-channel audio signal from a stereo channel audio signal includes a front channel canceling unit to generate a surround channel audio signal through feed-forward mixing with a gain and delay, from an input stereo channel audio signal, and a level control unit to control an audio level of the surround channel generated in the front channel canceling unit according to the audio level characteristic of the input stereo channel and to generate a final surround channel audio signal according to the controlled audio level.

### CROSS-REFERENCE TO RELATED APPLICATIONS

This application claims priority under 35 U.S.C. §119(a) from Korean Patent Application No. 10-2005-0090721, filed on Sep. 28, 2005, in the Korean Intellectual Property Office, the disclosure of which is incorporated herein in its entirety by reference.

### BACKGROUND OF THE INVENTION

1. Field of the Invention

The present general inventive concept relates to an audio reproducing system, and more particularly, to an enhanced audio matrix decoding method and apparatus to generate a multi-channel audio signal from a stereo channel audio signal.

2. Description of the Related Art

Generally, ground wave broadcasting has been a main source of movies, and also video tapes, video discs, and satellite broadcasting have been widely used as another source of the movies. Accordingly, a user can enjoy original sound of the movies at home using the sources of the movies.

In the video tapes, video discs, and broadcastings providing the original sound, matrix processing of an audio signal with a plurality of channels is performed to encode the audio signal into a 2-channel audio signal. The 2-channel audio signal encoded using the matrix processing can be reproduced as stereo sound. In addition, when a dedicated decoder is used, a 5-channel audio signal, including front left (L), center (C), front right (R), left surround (Ls) and right surround (Rs) channels, can be restored from a 2-channel audio signal. Among these 5 channels of the audio signal, a center channel signal plays a role of obtaining a correct location that is for clearness of sound, and a surround channel signal improves actual feeling with moving sound, environment sound, and echo sound.

A matrix decoder generally used generates a center channel and a surround channel by using a sum and difference of two channel signals. An audio matrix in which matrix characteristics are not changed is known as a passive matrix decoder. An active matrix decoder adaptively changes the decoding matrix characteristics in order to improve separation among 2-channel matrix encoding signals.

A technology related to a conventional active matrix decoder is disclosed in the U.S. Pat. No. 4,779,260 entitled a ‘variable matrix decoder, and WO 02/19768 A 2 entitled a ‘method and apparatus for audio matrix decoding’.

In the conventional active matrix decoder, band-pass filtering of two channel matrix encoding signals (Lt, Rt) is performed to prevent arbitrary decoding errors. Also, by using a signal obtained by adding a left channel signal and a right channel signal, and a signal obtained by subtracting the right channel signal from the left channel signal, a surround channel signal and a center channel signal are generated. Then, from the four channel signals, a sound amount difference between the two channel matrix encoding signals (Lt, Rt) is obtained and a magnitude of an orthogonal signal pair of sound amounts of the surround channel signal and the center channel signal is determined. With the magnitude of the orthogonal signal pair of the signals, relative dominance is checked and four unipolar control voltages, EL, ER, EC, and ES, are obtained. By using the unipolar control voltages and two channel matrix encoding signals (Lt, Rt), a matrix minimizing an interference between signals is obtained. Then, by using the obtained matrix, L, C, R, Rs, and Ls are obtained from the two channel matrix encoding signals (Lt,. Rt).

However, though signals having no mutual interference can be obtained from the two channel matrix encoding signals (Lt, Rt), the conventional active matrix decoder has disadvantages in the complexity of the calculation. Also, performance in relation to an ordinary stereo signal that is not the two channel matrix encoding signals (Lt, Rt) cannot be obtained. Furthermore, if a mono-like stereo signal is input to the conventional active matrix decoder, the signal obtained by subtracting the surround channel signal from the left channel signal becomes smaller such that relative dominance is inclined to the front channel.

### SUMMARY OF THE INVENTION

The present general inventive concept provides an enhanced audio matrix decoding method and apparatus that can be used to generate a stereo signal as well as two channel matrix encoding signals (Lt, Rt) and have smaller amount of computation.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an audio matrix decoding apparatus to generate a multi-channel audio signal from a stereo channel audio signal, the audio matrix decoding apparatus including a front channel canceling unit to generate a surround channel audio signal through feed-forward mixing with a predetermined delay, from the stereo channel audio signal, and a level control unit to control an audio level of the surround channel generated in the front channel canceling unit according to an audio level characteristic of the stereo channel and to generate a final surround channel audio signal.

The automatic level control unit may include an audio level adjustment unit analyze the audio level characteristics of the input stereo channel and the surround channel, and to generate a gain value so that a level difference of the stereo channel and the surround channel becomes a set value, and a multiplication unit to multiply the audio level of the surround channel by the gain value generated in the audio level adjustment unit, and to generate the final surround channel audio signal.

The foregoing/or other aspects of the present general inventive concept may also be achieved by providing an audio matrix decoding method of generating a multi-channel audio signal from a stereo channel audio signal, the audio matrix decoding method including generating a surround channel audio signal through feed-forward mixing with a predetermined delay, from the input stereo channel audio signal, and analyzing audio level characteristics of the input stereo channel and the surround channel audio signal, controlling an audio level of the surround channel audio signal with respect to the analyzed level characteristics, and generating a final surround channel audio signal according to the controlled audio level of the surround channel audio signal.

The foregoing/or other aspects of the present general inventive concept may also be achieved by providing a computer readable recording medium containing computer readable codes which are readable by a computer to perform an audio matrix decoding method, the audio matrix decoding method including generating a surround channel audio signal through cross mixing with a gain and delay, from the input stereo channel audio signal, and analyzing the audio level characteristics of the input stereo channel and the surround channel, controlling the audio level of the surround channel with respect to the analyzed level characteristics, and generating a final surround channel audio signal.

The foregoing/or other aspects of the present general inventive concept may also be achieved by providing an audio matrix decoding apparatus to generate a multi-channel audio signal from an audio signal, the audio matrix decoding apparatus including a front channel canceling unit to generate input surround channel signals from an audio signal, and a level control unit to control an audio level of the input surround channel signals according to an audio level characteristic of the audio signal to generate a final surround channel audio signal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an entire audio reproducing system having an enhanced audio matrix decoder according to an embodiment of the present general inventive concept;

FIG. 2 is a block diagram illustrating an enhanced audio matrix decoding apparatus according to an embodiment of the present general inventive concept; and

FIG. 3 is a detailed block diagram illustrating a front channel canceling unit and an automatic level control unit of the audio matrix decoding apparatus of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

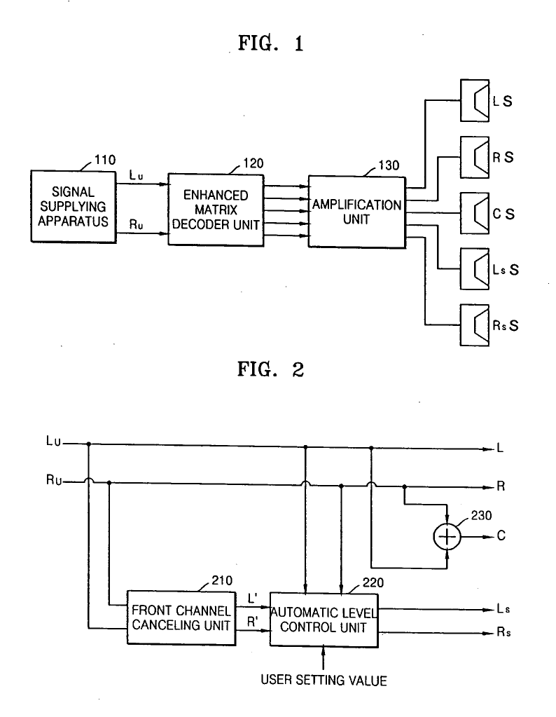

FIG. 1 is a block diagram illustrating an audio reproducing system having an enhanced audio matrix decoder according to an embodiment of the present general inventive concept.

Referring to FIG. 1, a signal supplying apparatus 110 receives a signal from a recording medium, such as a video tape, a video disc, or satellite broadcasting, and reproduces a video signal and an audio signal from the received signal. An image signal corresponding to the video signal is supplied to a monitor (not shown) and two channel audio signals (Lu, Ru) corresponding to the audio signal are provided to an enhanced matrix decoder unit 120 as an input signal. The two channel audio signals may be two unknown channel audio signals.

The enhanced matrix decoder unit 120 delays and cross-mixes the two channel signals (Lu, Ru) and adjusts signal levels with respect to a power level of the input signal. By doing so, the enhanced matrix decoder unit 120 generates audio signals of a front left channel, a front right channel, a center channel, a left surround channel, and a right surround channel.

An amplification unit 130 amplifies the audio signal of each channel output from the enhanced matrix decoder unit 120, and outputs the amplified audio signals to a front left speaker (LS), a front right speaker (RS), a center speaker (CS), a left surround speaker (LsS) and a right surround speaker (RsS).

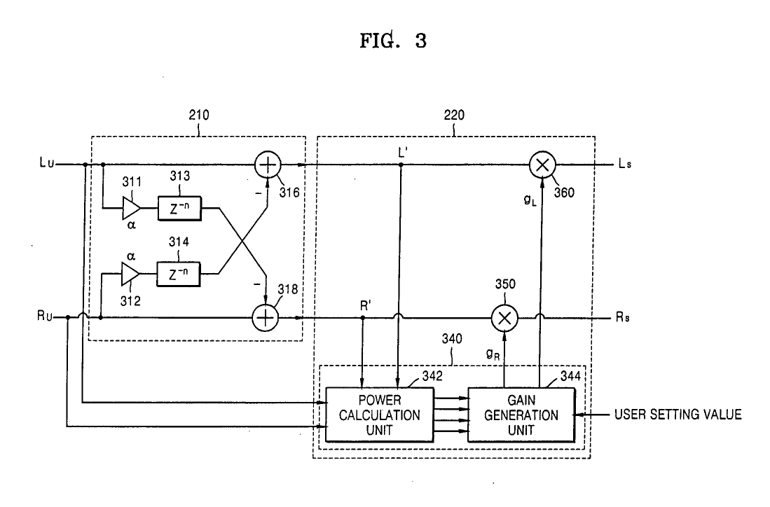

FIG. 2 is a block diagram illustrating an enhanced audio matrix decoding apparatus according to an embodiment of the present general inventive concept.

Referring to FIGS. 1 and 2, the enhanced audio matrix decoding apparatus of FIG. 2 may correspond to the enhanced matrix decoding unit 120 of FIG. 1 and includes a front channel canceling unit 210, an automatic level control unit 220, and an adder unit 230.

A vocal component may exist in the front left and/or right channels and the center channel.

With the tow left and right channel audio signals (Lu, Ru), the front channel canceling unit 210 removes the vocal component of the front channel (L, R) by feed-forward cross mixing with a predetermined delay and improves stereo feeling. That is, the front channel canceling unit 210 generates the audio signals of the left and right surround channels by removing an interference of the audio signals (L, R) of the front left and right channels as much as possible. Accordingly, the audio signals of the input left and light channels (Lu, Ru) are converted into surround channel audio signals (L′, R′) in which the vocal component is removed by the front channel canceling unit 210.

The automatic level control unit 220 analyzes each level characteristic of the input left and right channel audio signals (Lu, Ru) and the input left and right surround channel audio signals (L′, R′), obtains a gain determining a level of final left and right surround channel audio signals (Ls, Rs), from the analyzed level characteristic, and generates the final left and right surround channel audio signals (Ls, Rs) obtained by applying the gain to the left and right surround channel audio signals (L′, R′). That is, the automatic level control unit 220 adjusts the surround channel audio signals (L′, R′) to a predetermined level, for example, a user set level, regardless of level characteristic of the input left and right channel audio signals (Lu, Ru).

The adder unit 230 generates the center channel audio signal by adding the input left and right channel audio signals (Lu, Ru). That is, C=Lu+Ru.

Accordingly, the left and right channel audio signals (Lu, Ru) are used to generate the final front left channel audio signal (L), the final front right channel audio signal (R), the final center channel audio signal (C), the final left surround channel audio signal (Ls), and the final right surround channel audio signal (Rs) through the audio matrix decoding apparatus. Though stereo channels are explained as an example in the present embodiments, it will be understood by those of ordinary skill in the art that the present embodiment can be applied to other multi-channel signals, such as 2.1 channels and 5.1 channels.

FIG. 3 is a detailed block diagram illustrating the front channel canceling unit 120 and the automatic level control unit 220 of the audio matrix decoding apparatus of FIG. 2.

Referring to FIGS. 2 and 3, the front channel canceling unit 210 will now be explained hereinafter.

A first gain adjuster 311 and a second gain adjuster 312 adjust the level of the audio signals input to the left and right channels, with a predetermined gain value (α).

A first delay 313 and a second delay 314 delay the left and right channel audio signals, in which gains are adjusted in the first and second gain adjusters 311 and 312, for a predetermined time with a predetermined delay value (Z⁻ⁿ).

At this time, the delays 313 and 314 may have a short delay (Z⁻ⁿ) of 1 or 2 samples.

A left subtracter 316 obtains a difference of the left channel audio and the right channel audio signal that is gain-adjusted with the gain value (α) and delayed with the delay value (Z⁻ⁿ), and generates the left surround channel audio signal (L′).

A right subtracter 318 obtains a difference of the right channel audio and the left channel audio signal that is gain-adjusted with the gain value (α) and delayed with the delay value (Z⁻ⁿ), and generates the right surround channel audio signal (R′).

Accordingly, the front channel canceling unit 210 removes common components between the left and right channel signals, by obtaining the difference between the two channels in the form of cross mixing with the gain and delay. Accordingly, stereo feeling is improved and clearness and separation can be enhanced because information in a high frequency region and a low frequency region can be restored more than that obtained by simply subtracting the right channel audio signal from the left channel audio signal.

The automatic level control unit 220 will now be explained in detail.

The automatic level control unit 220 includes an audio level adjusting unit 340 having a power calculation unit 342 and a gain generation unit 344, and a first multiplication unit 360, and a second multiplication unit 350.

The power calculation unit 342 calculates the root square mean (RMS) values of the input left and right channel audio signals Lu and Ru and the left and right surround channel audio signals L′ and R′.

The gain generation unit 344 generates a first gain value (g_{L}) so that a difference of the RMS value of the left channel audio signal Lu and the RMS value of the left surround channel signal L′ calculated in the power calculation unit 342 can be a user setting value.

Also, the gain generation unit 344 generates a second gain value (g_{R}) So that a difference of the RMS value of the right channel audio signal Ru and the RMS value of the right surround channel signal R′ calculated in the power calculation unit 342 can be a user setting value. That is, the first and second gain values (g_{L}, g_{R}) can be calculated according to the following equations 1 and 2:
P_{Lu}−g_{L}P_{L′}=D(dB) (1)

where P_{Lu} denotes the RMS value of the left channel signal, P_{L′} denotes the RMS value of the left surround channel signal, and D denotes a user setting value.
P_{Ru}−g_{R}P_{R′}=D(dB) (2)

where P_{Ru} denotes the RMS value of the right channel signal, P_{R′} denotes the RMS value of the right surround channel signal, and D denotes a user setting value.

The first multiplication unit 360 multiplies the left surround channel audio signal (L′) by the first gain value (g_{L}) generated in the gain generation unit 344 and outputs the final left surround channel audio signal (Ls).

The second multiplication unit 350 multiplies the right surround channel audio signal (R′) by the second gain value (g_{R}) generated in the gain generation unit 344 and outputs the final right surround channel audio signal (Rs).

Accordingly, the automatic level control unit 220 can adjust the level of the surround channel audio signal Ls or Rs to a degree desired by a user, by analyzing the level characteristic of the input left and right channel audio signals L′ and R′, can also increase separation of channels by controlling a magnitude of each surround channel audio signal L′ or R′ with respect to a magnitude of the input signal Lu or Ru, and can prevent signal clipping by adjusting the level of the final surround channel audio signals LS and Rs.

The final left and right surround channel audio signals (Ls, Rs) can be expressed as the following equation 3 and 4:
Ls=g_{L}·(Lu−αZⁿ·Ru) (3)
Rs=g_{R}·(Ru−αZⁿ·Lu) (4)

The present general inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the present general inventive concept as described above, the level characteristics of the left and right channels are reflected and a multi channel audio signal can be generated by unknown stereo input signal as well as the two channel matrix encoding signals (Lt, Rt). Also, the present invention can overcome the limitation of sound quality that the conventional passive matrix stricture has. While accommodating the advantages of the active matrix structure, the present general inventive concept reduces the amount of computation amount such that it can be applied effectively to the application fields, such as a virtual sound.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An audio matrix decoding apparatus to generate a multi-channel audio signal from a stereo channel audio signal, comprising:
a front channel canceling unit to generate a surround channel audio signal through cross mixing with a gain and delay, from the stereo channel audio signal; and
a level control unit to control an audio level of the surround channel generated in the front channel canceling unit according to an audio level characteristic of the stereo channel audio signal and to generate a final surround channel audio signal according to the controlled audio signal.

2. The apparatus of claim 1, wherein the stereo channel audio signal comprises left and right channel audio signals.

3. The apparatus of claim 1, wherein the front channel canceling unit comprises:
left and right gain adjustment units to adjust gains of left and right channel input signals;
left and right signal delay units and a right signal delay unit to delay the left and right channel input signals adjusted in the left and right gain adjustment unit, for a predetermined time;
a first left subtracter unit to obtain a difference of the left channel input signal and the right channel input signal delayed in the right signal delay unit; and
a first right subtracter unit to obtain a difference of the right channel input signal and the left channel input signal delayed in the left signal delay unit.

4. The apparatus of claim 1, wherein the automatic level control unit comprises:
an audio level adjustment unit to analyze audio level characteristics of the input stereo channel and the surround channel, and to generate a gain value so that the level difference of the stereo channel and the surround channel becomes a set value; and
a multiplication unit multiply the audio level of the surround channel by the gain value generated in the audio level adjustment unit, and to generate the final surround channel audio signal.

5. The apparatus of claim 4, wherein the audio level adjustment unit comprises:
a power calculation unit to calculate the root square mean (RMS) value of each of the input left and right channel audio signals and the left and right surround channel audio signals;
a gain generation unit to generate a first gain value so that the difference of the RMS values of the left channel signal and the left surround channel signal calculated in the power calculation unit becomes a preset value, and to generate a second gain value so that the difference of the RMS values of the right channel signal and the right surround channel signal calculated in the power calculation unit becomes a preset value;
a first multiplication unit to multiply the left surround channel audio signal by the first gain value generated in the gain generation unit, and to output a final left surround channel audio signal;
a second multiplication unit to multiply the right surround channel audio signal by the second gain value generated in the gain generation unit, and to output a final right surround channel audio signal.

6. An audio matrix decoding apparatus to generate a multi-channel audio signal from a stereo channel audio signal, comprising:
a front channel canceling unit to generate a surround channel audio signal through cross mixing with a gain and delay, from the input stereo channel audio signal;
an audio level adjustment unit to analyze audio level characteristics of the input stereo channel and the surround channel, to control the audio level of the surround channel generated in the front channel canceling unit with respect to the analyzed level characteristics and a setting level, and to generate a final surround channel audio signal according to the controlled audio level; and
an adder unit to generate a center channel audio signal by adding the input left and right channel audio signals.

7. An audio matrix decoding method of generating a multi-channel audio signal from a stereo channel audio signal, the audio matrix decoding method comprising:
generating a surround channel audio signal through cross mixing with a gain and delay, from the input stereo channel audio signal; and
analyzing the audio level characteristics of the input stereo channel and the surround channel, controlling the audio level of the surround channel with respect to the analyzed level characteristics, and generating a final surround channel audio signal.

8. The method of claim 7, wherein the generating of the surround channel audio signal comprises:
expanding left channel stereo feeling by obtaining the difference of the left channel audio signal and the right channel input signal that is delayed for predetermined samples; and
expanding right channel stereo feeling by obtaining the difference of the right channel input signal and the left channel input signal that is delayed for predetermined samples.

9. The method of claim 7, wherein the generating of the final surround channel audio signal comprises:
calculating the power value of each of the input left and right channel audio signals and the left and right surround channel audio signals;
generating a first gain value so that the difference of the power values of the left channel signal and the left surround channel signal becomes a preset value;
generating a second gain value so that the difference of the power values of the right channel signal and the right surround channel signal becomes a preset value; and
generating a final left surround channel audio signal by multiplying the left surround channel audio signal by the first gain value, and generating a final right surround channel audio signal by multiplying the right surround channel audio signal by the second gain value.

10. A matrix decoding apparatus of an audio reproducing system comprising:
a signal supplying apparatus to reproduce a stereo channel audio signal;
a matrix decoder unit to generate a surround channel audio signal through cross mixing with a gain and delay, from the stereo channel audio signal, to control the audio level of the surround channel according to the audio level characteristic of the input stereo channel, and to generate a final surround channel audio signal according to the controlled audio level; and
an amplification unit to amplify each channel audio signal generated from the matrix decoder unit, and to output the audio signal to a speaker terminal corresponding to the channel.

11. A computer readable recording medium containing computer readable codes which are readable by a computer to perform an audio matrix decoding method, the audio matrix decoding method comprising:
generating a surround channel audio signal through cross mixing with a gain and delay, from the input stereo channel audio signal; and
analyzing the audio level characteristics of the input stereo channel and the surround channel, controlling the audio level of the surround channel with respect to the analyzed level characteristics, and generating a final surround channel audio signal.

12. An audio matrix decoding apparatus to generate a multi-channel audio signal from an audio signal, comprising:
a front channel canceling unit to generate input surround channel signals from an audio signal: and
a level control unit to control an audio level of the input surround channel signals according to an audio level characteristic of the audio signal to generate a final surround channel audio signal.

13. The apparatus of claim 12, wherein the front channel canceling unit removes a vocal component from the audio signal to generate the input surround channel signals.

14. The apparatus of claim 12, wherein the front channel canceling unit removes an interference of front left and right channels of the audio signal to generate the input surround channel signals.

15. The apparatus of claim 12, wherein the audio signal comprises left and right channel signals, and the front channel canceling unit adjusts gains of the left and right channel signals, delays the gain-adjusted left and right channel signals, and subtracts the delayed gain-adjusted left and right channel signals from the right and left channel signals, respectively, to generate the input surround channel signals.

16. The apparatus of claim 12, wherein the audio signal comprises left and right channel signals, and the level control unit controls the input surround channel signals according to a level characteristic of the left and right channel signals of the audio signal to generates the final surround channel signals.

17. The apparatus of claim 12, wherein the audio signal comprises left and right channel signals, and the level control unit controls levels of the input surround channel signals according to a gain obtained from a level characteristic of the left and right channel signals of the audio signal to generate the final surround channel signals.

18. The apparatus of claim 12, wherein the audio signal comprises left and right channel signals, and the level control unit applies gains obtained from level characteristics of the left and right channel signals of the audio signal to the input surround channel signals to generates the final surround channel signals.

19. The apparatus of claim 12, wherein the audio signal comprises left and right channel signals, and the level control unit adjusts levels of the input surround channel signals according to a user preference to generate the final surround channel signals.

20. The apparatus of claim 12, wherein the level control unit applies one of a user preference and a characteristic of the audio signal to the input surround channel signals to generate the final surround channel signals.
